(19) United States
(12) Patent Application Publication
(10) Pub. No.: US 2011/0264269 A1
(43) Pub. Date: Oct. 27, 2011

(54) Ignition System Having Control Circuit With Learning Capabilities and Devices and Methods Related Thereto

(76) Inventor: Thomas A. Chodacki, Stow, MA (US)

(21) Appl. No.: 13/092,839

(22) Filed: Apr. 22, 2011

Related U.S. Application Data
(60) Provisional application No. 61/327,649, filed on Apr. 23, 2010.

(51) Int. Cl. G05B 21/00

(52) U.S. Cl. 700/274

(57) ABSTRACT

Featured is an ignition system using miniaturized hot surface igniters of various types, configurations, and material systems. The ignition system includes an electronic microprocessor on which a software program is executed so as to control the operation of an igniter and all functions of the ignition system. The software program evaluates performance characteristics relating to operation of the igniter. Additionally, the software program determines operation parameters and characteristics for energizing the igniter when it determines that the operation parameters and characteristics for energizing should be updated or revised.

This application claims the benefit of U.S. Provisional Application Ser. No. 61/327,649 filed Apr. 23, 2010, the teachings of which are incorporated herein by reference.

### FIELD OF INVENTION

The present invention relates to control systems for fuel burner igniters and more particularly to control systems for electrical resistance-type igniters for fuel burners and methods for determining and controlling the voltage to, and the “on time” duration for, such electrical resistance-type igniters.

### BACKGROUND OF THE INVENTION

There are a number of appliances such as cooking ranges and clothes dryers, and heating apparatuses such as boilers and furnaces in which a combustible material, such as a combustible hydrocarbon (e.g., propane, natural gas, oil) is mixed with air (i.e., oxygen) and continuously combusted within the appliance or heating apparatus so as to provide a continuous source of heat energy. This continuous source of heat energy is used, for example, to cook food, heat water to supply a source of running hot water, and heat air or water to heat a structure such as a house.

Because this mixture of fuel and air (i.e., fuel/air mixture) does not self-ignite when mixed together, an ignition source is provided to initiate the combustion process and to continue operating until at least the combustion process is self-sustaining. In the not too distant past, the ignition source was what was commonly referred to as a pilot light in which very small quantities of the combustible material and air were mixed and continuously combusted even while the heating apparatus or appliance was not in operation. For a number of reasons, the use of a pilot light as an ignition source was done away with and an igniter used instead.

An igniter is a device that creates the conditions required for ignition of the fuel/air mixture on demand, including spark-type igniters such as piezoelectric igniters and hot surface-type igniters such as silicon carbide ceramic intermetallic hot surface igniters. Spark-type igniters that produce an electrical spark that ignites gas advantageously provide very rapid ignition, which is to say, ignition within a few seconds. Problems with spark-type igniters, however, include, among other things, the electronic and physical noise produced by the spark.

Also, the circuitry of the spark type ignition device is sometimes packaged in a module that is electrically connected between a cook top power supply and the cook top burner system. Power supply phase conductors and neutral conductors are input to the module, and the module output is fed to an electrode and an igniter for ignition or re-ignition of the burner flame as necessary. Known ignition modules for gas-fired burners, however, are susceptible to malfunctions in use. For example, the phase and neutral conductors of an alternating current power supply can sometimes be reversed and cause the modules to continuously spark. In addition, the modules are often sensitive to voltage on the neutral conductor which desensitizes the flame detection circuit and can lead to continuously generated sparks despite the presence of a flame on a burner. Still further, proper operation of the ignition modules is dependent upon proper connection of ground conductors and neutral conductors in electrical junction boxes that feed the ignition module in use. If the electrical junction box is not properly wired, the ignition module will continuously spark. Unnecessary sparking of the ignition module reduces energy efficiency and also shortens a useable life of the ignition module.

With hot surface igniters, such as the silicon carbide ceramic intermetallic hot surface igniter, the heating tip or element is resistively heated by electricity to the temperature required for the ignition of the fuel/air mixture, thus when the fuel/air mixture flows proximal to the igniter it is ignited. This process is repeated as and when needed to meet the particular operating requirements for the heating apparatus/appliance. Hot-surface-type igniters are advantageous in that they produce negligible noise in comparison to spark-type igniters. Hot surface-type igniters, however, can require significant ignition/warm-up time to resistively heat the resistance igniter sufficiently to a temperature that will ignite the fuel-air mixture (e.g., gas-air). In some applications, this warm-up time can vary between about 15 and about 45 seconds.

Various efforts have been undertaken to improve or shorten the time taken to heat-up a hot surface igniter to the ignition temperature while at the same time not exceeding a temperature that likely could lead to failure of the igniter. While certain of these efforts have been successful, other factors work so as to limit the usable service life of an igniter. For example, hot surface igniters have a typical aging characteristic where the resistance of the igniter increases over time which in turns leads to a decrease in the igniter operating temperature and an increase in the igniter's warm up time. These two factors work to limit igniter usable life.

In U.S. Pat. No. 3,589,846 there is found a burner ignition and control system including two solenoid valves connected in series between the fuel supply and burner. An electrical resistance-type igniter is provided to cause ignition and a sensor determines when the igniter is in ignition condition and when combustion occurs properly. The circuit is arranged to provide automatic recycling when combustion does not occur or is prematurely terminated. A delay is provided when recycling occurs during which the burner and related system is purged of unburned fuel or products of combustion. The sensor is an ambient temperature compensated device operated by a bimetallic element to sense the rate of radiant heat emission from the igniter and burner. The sensor is not directly exposed to the high temperature conditions at the igniter and in the combustion zone so a simple bimetallic element is directly connected to operate the sensor switch.

In U.S. Pat. No. 4,925,386, there is found a gas burner control system that includes an electrical resistance igniter, gas valve means, and a microcomputer and related circuitry. The microcomputer and related circuitry control energize the igniter in such a manner so that the igniter, after successive ignition attempts, will eventually, in response to a learning routine, be heated to a desired ignition temperature. The microcomputer and related circuitry also control operation of a circulator blower in response to burner flame and provide for numerous checks on the integrity of system components.

In U.S. Pat. No. 5,660,043, there is found a gas turbine combustor that is improved by mounting a pilot flame producing torch in a wall of the combustor to project a flame into the combustor as a means of ignition. The torch preferably is a catalytic igniter which will operate over a wide range of air/fuel ratios.

In U.S. Pat. No. 5,725,386, there is found a system for enabling an electrical resistance igniter to attain ignition temperature within a few seconds and without exceeding a temperature that could damage the igniter. The system controls the level of power to the igniter based on the determined value of voltage available to energize the igniter and on the determined value of the igniter resistance.

In U.S. Pat. No. 6,322,352, there is found a gas burner for a stove or cook top. Such a stove burner safety system includes an electromagnetic valve and a manual gas cock controlling the gas flow to the burner and a spark plug adjacent the burner which receives a spark pulse from the electric circuitry or electric module which also controls the electromagnetic valve. When the stem of the manual valve is actuated (i.e., pushed in) a switch turns on the electric module. If a flame failure is detected, a train of a certain number of spark pulses is supplied to the spark plug and if re-ignition does not occur within a certain number of pulses or a certain time, the electromagnetic valve is turned off. This system is arranged to use an electromagnet valve that is opened or closed by a signal and a manual valve that initially supplies the gas to start the combustion process.

In U.S. Pat. No. 6,923,640, there is found a flame burner ignition system that includes a burner, a power supply, an electrical system including a ground conductor, and an ignition module. The ignition module includes a first input, a second input, and an output. The output is operatively coupled to the burner, while one of the inputs is coupled to the ground conductor, and the other of the inputs is coupled to the power supply. The described system also includes an isolation transformer that is connected between a junction box and the ignition module. As the ignition module is isolated from the power source, a reversal of the line or phase conductor and the neutral conductor does not affect the ignition module. In this way, it is described that the ignition module will operate correctly despite improper wiring of the junction box and so that a false detection of an extinguished flame is not detected by the flame sensing circuitry.

Thus, there continues to be a need for ignition systems that embody mechanisms to reduce warm-up or heat-up time for an igniter. Preferably such systems also would embody mechanisms for controlling igniter operation so as to minimize aging of the igniter. It thus would be desirable to provide a fuel gas ignition system or control system for gas burners that uses hot surface igniters such as miniaturized hot surface igniters and which includes mechanisms or control circuitry for reducing warm-up or heat-up time for an igniter and for controlling igniter operation so as to minimize aging of the igniter. It would be particularly desirable to provide such a control system that embodies intelligent control circuitry that is configured and arranged so as to determine, using information acquired during operation of the ignition system, control parameters (e.g., voltage level(s), voltage regulation times) so that the igniter achieves the minimum igniter temperature for reliable ignition of the fuel/air mixture and limiting impact to igniter with respect to aging. Preferably such an ignition control system would not increase the complexity of operation of the heating device or appliance in comparison to prior art devices.

### SUMMARY OF THE INVENTION

The present invention features an ignition system and methods for controlling ignition such as controlling the energization of the igniter device. In particular, such controlling includes determining operational parameters or characteristics for the supply voltage energizing the igniter device. As used herein, the term “fuel” includes any combustible or ignitable material. The term “fuel” and “gas” may be used interchangeably throughout this specification.

In particular embodiments, such an ignition system includes a miniaturized hot surface igniter that can be any of a number of various types configurations and material systems, a gas valve and an microcontroller or microprocessor.

In further embodiments, such an ignition system includes a microcontroller or microprocessor including a software program having code segments, instructions and criteria for controlling operation of the igniter, operation of the gas valve and the ignition of the gas by the igniter. The software program or a second software program that interfaces with the software program includes code segments, instructions and criteria for determining operational parameters or characteristics for the supply voltage energizing the igniter device(s).

Such an ignition system further includes a flame sensing means for continuously sensing the presence or absence of a burner flame by any of a number of techniques known to those skilled in the art, including the flame rectification technique, a UV sensing technique, and a temperature measurement technique. In more particular embodiments, the flame rectification circuit design is established to eliminate the need for earthing or a ground, by the use of a comparator circuit actuated by a burner flame present between the igniter element and igniter assembly shielding.

In yet further embodiments, a signal from the flame sensing means that is representative of the time of ignition, is used to determine operational parameters or characteristics for the supply voltage energizing the igniter device(s).

In more particular embodiments, the instructions and criteria further include instructions and criteria for using the flame sensing signal to trigger an electronically actuated gas valve of a type commonly used in the industry. Specifically, the ignition system is configured so that it can operate a millivolt type electronic gas safety valve via the flame sensing circuit.

In yet more particular embodiments, the control circuitry is configured and arranged or the software programs are established to perform a determination of the operational parameters or characteristics for each successful ignition. In this way, the control circuitry continuously monitors ignition system performance and adjusts operational parameters or characteristics so as to reflect the conditions seen for the most recent ignition. In more particular embodiments, the decision whether or not to adjust is based on the time for ignition and whether this time is within a specific or desired time range.

If the actual time for ignition is within the specified or desired range, then the operational parameters or characteristics need not be adjusted. As the operational parameters or characteristics need not be changed, when the next ignition request is received, the ignition parameters or characteristics would be those used for the prior ignition sequence.

If, on the other hand, the actual time for ignition is not within the specified or desired range, then a process is undertaken to determine the new operational parameter(s) or characteristic(s). Thus, the operational parameters or characteristics are changed or adjusted, such that the time for ignition should be in the desired range for the next ignition request. Thus, when the next ignition request is received, the new ignition parameters or characteristics are used when heating up the igniter.

In further embodiments, the control circuitry/software also is configured and arranged so as to re-adjust operational parameters/characteristics so as to cause an incremental reduction of the igniter temperature. In this way, the operational parameters/characteristics are adjusted so as to arrive at the operational conditions corresponding to the minimum temperature required for ignition.

In operation, it is possible that the fuel/air mixture will not ignite (non-ignition) in response to a received signal representative of an ignition request notwithstanding any actions taken previously to cause ignition to occur. In such a case, the control circuitry/software performs a process that makes multiple attempts to start ignition after such an ignition failure. In one embodiment, such multiple tries or attempts are done using the same operational parameters/characteristics. In another embodiment, the control circuitry/software is configurable so that the operational parameters/characteristics (e.g., supply voltage, jump start timings) for one or more of these additional tries are adjusted and these new operational parameters/characteristics are used to heat-up the igniter for the next ignition attempt.

In an illustrative embodiment, one mode of operation used in connection with operation of a burner is sometimes termed the constant ON mode. In this mode, the ignition system, more particularly the control circuitry/software thereof, is configured so that the igniter remains energized after receipt of the ignition request and after the fuel/air mixture fuel has ignited. This is generally done to make sure that if a burner goes out, the igniter which is being maintained in a hot state will re-ignite the flowing fuel/air mixture.

In another illustrative embodiment, another mode of operation involves turning the igniter off or reducing the supply voltage to the igniter after ignition has been determined to occur (i.e., sensing the presence of a flame). This process minimizes, if not removes, the potential for the igniter overheating as well as limiting the time at which the igniter is at its operating temperature.

After igniter activation and after determining that ignition has occurred, the microcontroller continuously monitors the burner flame. In the event of a loss of burner flame, the microcontroller powers the igniter for a defined igniter activation period to attempt to re-light the burner. In further embodiments, multiple trials for ignition are programmed into the microcontroller. The microcontroller also is operated so that there is near instantaneous shut down of the gas valve by the flame sensing circuit thereby essentially eliminating the possible flow of raw un-lit gas to the appliance.

In further embodiments, the electronic control functionalities are either AC or DC voltage powered.

In more particular embodiments, the microcontroller is configured so that the igniter is heated up to the ignition temperatures and can achieve ignition of the fuel within time periods established by industry standards or practices. In yet more particular embodiments, the microcontroller is configurable so as to bring the hot surface igniter to ignition temperature in 2 seconds or less.

In yet further embodiments, the control system, or more specifically at least the microcontroller, is continuously powered.

In yet further embodiments, the microcontroller is configured to check the flame sensing signal at the end of burner operation. In the event that the microcontroller detects that a flame is still present after the end of a burning operation, potentially indicating that the closure of the gas valve has failed to have properly occurred, the microcontroller is configured to reactivate the valve opening and closure sequence as an attempt to properly close the gas valve. A number of opening and closing sequences can be conducted as required. The microcontroller also is configurable to cause an auditory and/or a visual signal to be outputted or communicated to the user to identify the faulted condition. In this way, an indication is provided to the user to allow him or her to determine the reason for the fault, to correct the fault, and/or to have the appliance serviced.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 is a perspective view of an exemplary conventional free standing gas range that can use the ignition system of the present invention.

FIG. 2 is a schematic block diagram view of the ignition system of the present invention including burning area elements and a gas supply line(s) for clarity.

FIG. 3 is a high level flow diagram of a process embodied in the ignition system of the present invention, more particularly a process embodied in the microcontroller of the ignition system for determining igniter ignition parameters/characteristics based on system or igniter performance and for controlling energization of the igniter based on such determined ignition parameters/characteristics.

FIGS. 4A and 4B are high level flow diagrams of the process embodied in the ignition system of the present invention, more particularly the process embodied in the microcontroller of the ignition system.

FIGS. 5A and 5B are various views of the insulator (FIG. 5A) and the shield feature (FIG. 5B) of a hot surface igniter usable with the ignition system of the present invention.

### DESCRIPTION OF THE PREFERRED EMBODIMENT

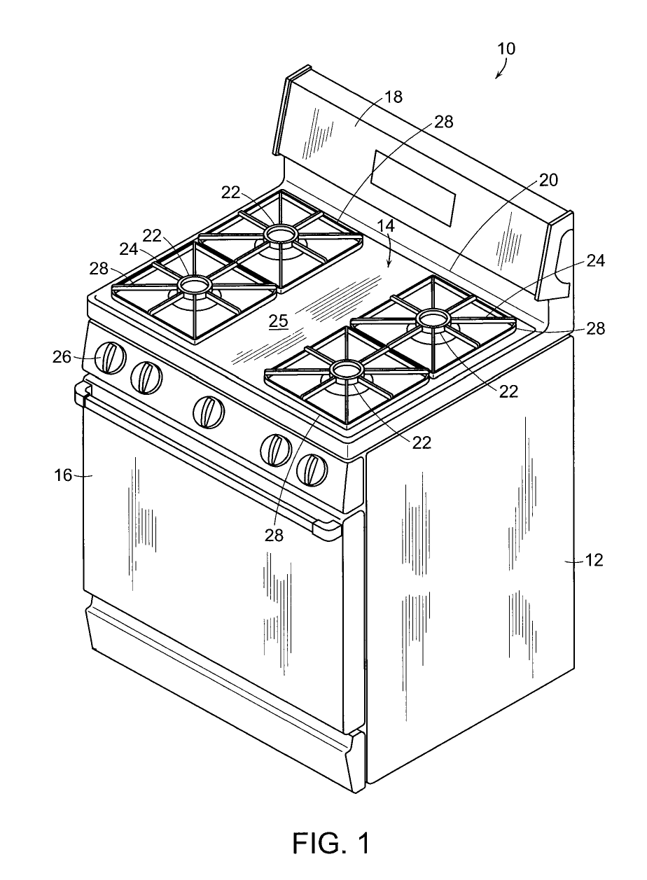

Referring now to the various figures of the drawing wherein like reference characters refer to like parts, there is shown in FIG. 1 an exemplary conventional free standing gas range 10 that includes an outer body or cabinet 12 that incorporates a generally rectangular cook top 14. An oven (not shown) is positioned below cook top 14 and has a front-opening access door 16. A range backsplash 18 extends upward of a rear edge 20 of the cook top 14 and contains various control selectors (not shown) for selecting operative features of the heating elements for cook top 14 and the oven.

In the exemplary free standing gas range 10, the cook top 14 includes four gas fueled burners 22 which are positioned in spaced apart pairs positioned adjacent each side of the cook top. Typically, each pair of burners 22 is surrounded by a recessed area 24 of the cook top 14. The recessed areas 24 are positioned below an upper surface 25 of the cook top 14 and typically serve to catch any spills from cooking utensils (not shown) being used with the cook top 14. Each burner 22 extends upwardly through an opening in the recessed areas 24, and a grate 28 is positioned over each burner 22. Each grate 28 includes a flat surface thereon for supporting cooking vessels and utensils over the burners 22 for cooking of meal preparations placed therein.

While the cook top 14 is shown with two pairs of grates 28 positioned over two pairs of burners 22, this shall not be considered limiting as it is known to those skilled in the art that cook tops are configurable so as to include greater or fewer number of burners. For example, the cook top can include three pairs of burners. As also known to those skilled in the art, such a cook top can be configured so as to provide a grilling surface or griddle which use burners as a heat source for grilling food or the cooking of food on the griddle. Further, the construction and operation of the cook top gas burners 22 are within the knowledge of those skilled in the art and thus further discussion of the details and construction of burners or the cook top is not discussed further herein.

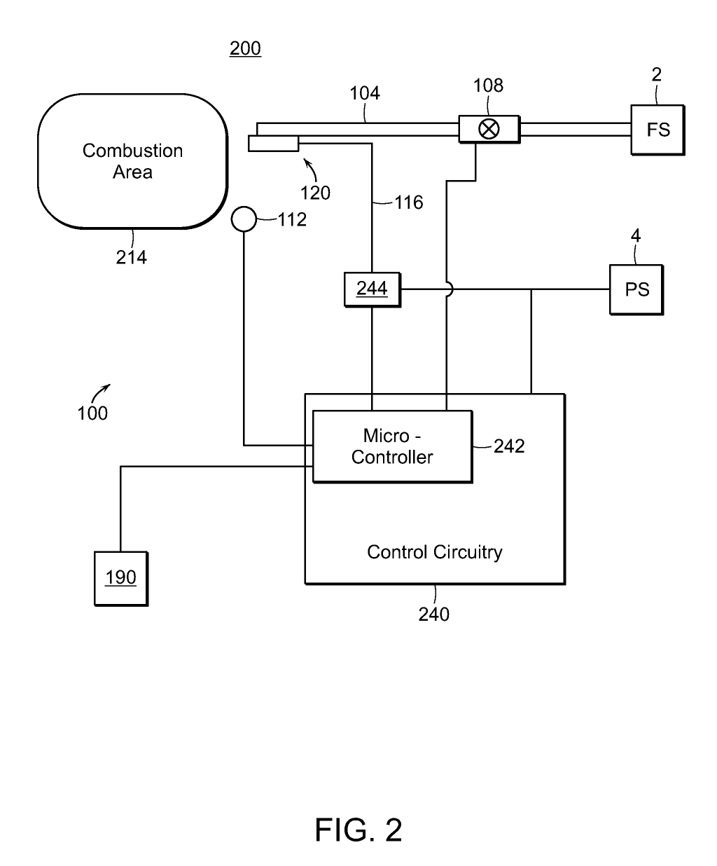

It should be recognized that the ignition system 100 (see FIG. 2) of the present invention can be embodied in cook tops which form the upper portion of a range, such as range 10, as well as with other forms of cook tops, such as, but not limited to, free standing cook tops that are mounted in kitchen counters. While the description herein makes general reference to a gas-fired cook top, it is contemplated, and thus within the scope of the present invention, for the ignition system of the present invention to be embodied with any of a number of other fuel burning apparatuses or combustion burners for a variety of combustible fuels as are known to those skilled in the art or hereinafter developed. Such other apparatuses or applications include, but are not limited to, gas heater devices, gas ovens, gas kilns, gas-fired meat smoker devices, and gas barbecues. In sum, the description provided below is therefore set forth only by way of illustration rather than limitation, and shall not be used to limit practice of the present invention to any particular application.

Referring now to FIG. 2, there is shown a simplified schematic block diagram view of a fuel burning apparatus 200 in the form of a cook top 200. It will be appreciated by those of skill in the art that the fuel burning apparatus 200 of the present invention may be a heating device or other fuel burning device. In one embodiment, a fuel burning apparatus 200 embodies or includes an ignition system 100 of the present invention and a combustion area 214. The ignition system 100 may include control circuitry 240 that embodies a microcontroller 242 that forms the controlling part of the ignition system 100. The cook top 200 being illustrated is described hereinafter as being used with a gaseous hydrocarbon (such as natural gas, propane) as the material to be combusted therein to produce the heat energy. This shall not be construed as a limitation as the materials used for combustion are not limited to gaseous hydrocarbons but may also include combustible liquid hydrocarbons and other gases (e.g., hydrogen) and liquids that continuously combust once they are ignited. Also, while a single combustion area 214 representative of a burner is shown, this also shall not be considered limiting as the number of combustion areas is dependent upon the type of heating device or appliance embodying the present invention.

The ignition system 100 includes one or more igniter devices 120, burner tubes 104, fuel admission valves 108, for each combustion area 214 or burner of the cook top 200. As described further herein, the ignition system 100 further includes igniter control circuitry 244 that is configured so that one or more supply voltages are applied to a hot surface igniter.

As described further herein, the one or more supply voltages, the timing for application of such supply voltages, and any termination of such application of supply voltages, are determined so that the igniter 120 is heated to an appropriate level or temperature for causing the fuel/air mixture to ignite. In addition, such a determination is made so that negative effects leading to aging of the igniter characteristics are minimized.

The device control circuitry 240, more specifically the microcontroller 242, is electrically interconnected and operably coupled to the fuel admission valve 108 and the igniter control circuitry 244 so each can be selectively operated to produce heat energy as hereinafter described.

The fuel admission valve 108 is fluidly interconnected to a fuel source 2 of a combustible material as the fuel for the heating device using piping or tubing. In the illustrated embodiment, the piping or tubing is interconnected to a source of a gaseous hydrocarbon such as natural gas or propane. The fuel source 2 can be one of an external tank or an underground natural gas piping system as is known to those skilled in the art.

The control circuitry 240, more specifically the microcontroller 242, is electrically interconnected to an external switch device 190 that provides the appropriate signals to the control circuitry 240 and/or microcontroller 242 for appropriate operation of the heating device. For example, in the case of a cook top, the external switch device 190 is a mechanical and/or electronic type of switch that can output one or more signals to the control circuitry 240 and/or microcontroller 242 so that a user can turn on the burner or other heating element (e.g., grill unit, griddle, oven) and initiate the ignition of the gas, to regulate or adjust gas flow so as to thereby control the amount of heat energy being developed by the burner (e.g., high through low), and to turn the burner off when heat energy is no longer wanted (e.g., a knob 26 provided with the cook top 200). If the combustion area is for a heating device such as a furnace to heat a building structure or a hot water heater then the external switch device 190 is a thermostat as is known to those skilled in the art that senses a bulk temperature within the building structure or the hot water in the tank. Based on the sensed temperatures, the thermostat outputs signals to the control circuitry 240, and/or the microcontroller 242, to turn the furnace or hot water heater on and off.

In use, the control circuitry 240 and/or microcontroller 242 receives a signal from the external switch device 190 calling for the cook top 200 or other heating device (e.g., stove burner, oven, hot water heater, furnace, etc) to be turned on. In response to such a signal, the microcontroller 242 outputs signals to the igniter control circuitry 244 so as to cause the hot surface igniter 120 to be heated up for ignition, (i.e., cause electricity to flow through the heating element of the igniter 120 to heat the heating element to the desired temperatures for causing a fuel/air mixture to ignite). These processes for energizing and heating of the igniter 120 and operation of the igniter control circuitry 244 are described further herein.

In a particular embodiment, after the igniter heating element is heated to the desired temperature, the fuel admission valve 108 is opened so that the fuel flows through the burner tube 104 to the igniter heating element. As is known in the art, air is mixed with the fuel that is presented to the igniter heating element so that a combustible mixture is thereby created and ignited by the igniter heating element. This ignited fuel/air mixture is located in the combustion area 214 so that useable heat energy can be extracted and used for the intended purpose of the heating device (e.g., to heat food or water). Although a single burner tube 104 is illustrated, as is known to those skilled in the art, a plurality or a multiplicity of burner tubes can be provided to generate a desired heat output where one or more fuel admission valves 108 can be provided for each burner tube. Typically, a plurality or multiplicity of burner tubes are arranged with respect to the hot surface igniter 120.

While the igniter 120 is generally described herein as a hot surface igniter this is a particularly preferred mechanism for causing the ignition of the fuel/air mixture. This embodiment shall not be considered as limiting as it is within the scope of the present invention for the combined ignition system 100 of the present invention to be adapted for use with any of a number of ignition devices as are known to those skilled in the art or hereinafter developed. Such ignition devices include spark type ignition devices.

A sensor 112 is typically located proximal the hot surface igniter and/or a region of the combustion area 214 for use in determining the presence or absence of combustion of the fuel/air mixture including the presence of continued combustion. In one embodiment, the sensor 112 is configured and arranged so as to embody the flame rectification method or technique. In another embodiment, the sensor 112 is a thermopile type of sensor that senses the temperature of the area in which the fuel/air mixture is being combusted. In yet further embodiments, the sensor 112 embodies UV sensing methods or techniques for detecting the presence of the flame. The foregoing are illustrative and thus the sensor or sensing device of the present invention shall not be limited to these specific techniques.

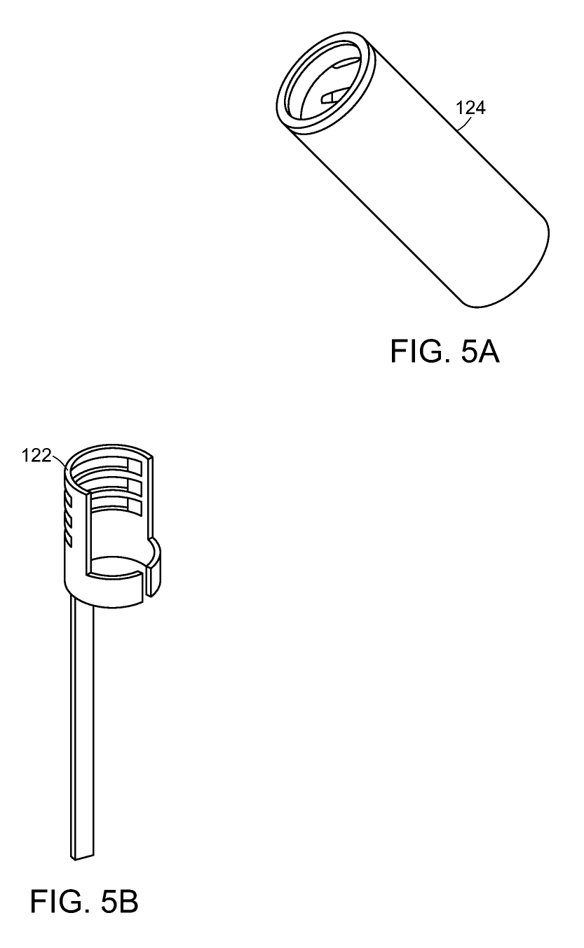

In further embodiments and with reference to the FIGS. 5A, B, the igniter 120 of the present invention is configured so to include an integrated flame sensing shield 122 (see FIG. 5B) that is secured to the insulator 124 (see FIG. 5A). Such a flame sensing shield 122 is configured so as to provide for an increase in the level of the flame sense signal due the unique shield geometry as compared to other shield designs.

The sensor 112 is interconnected to the control circuitry 240/microcontroller 242 so that if the sensor, for example, does not output a signal indicating the safe and continuous ignition of the fuel/air mixture within a preset period of time, the control circuitry shuts or closes the fuel admission valve 108. As also described herein, a signal is outputted to the control circuitry 240/microcontroller 242 indicating that ignition has started. From this, the control circuitry 240/microcontroller 242 determines the time taken from the initiation of the ignition process to the start of ignition, and the time of ignition, and thereafter determines if the time of ignition is within a desired time range or not. If the time is not within the desired time range, then the control circuitry 240/microcontroller 242 follows a process to determine a set of new ignition parameters or characteristics that should be utilized in the next ignition request for heating up the igniter to an ignition temperature.

As also described herein, the control circuitry 240/microcontroller 242 also is configured and arranged to repeat this attempt to ignite the fuel/air mixture to start the heating process one or more times. After ignition is obtained, signals are outputted to the igniter control circuitry 244 to cut off the electrical power to the hot surface igniter 120. In alternative embodiments, after ignition is obtained the control circuitry 240 continues to energize the igniter at or about the ignition temperature or at a lower temperature by appropriately controlling the supply voltage. Also, in the case where the control circuitry 240 is configured for the “jump start” ignition method, the control circuitry 240/microcontroller 242 is arranged so that after ignition is obtained the voltage is reduced to the next voltage level or less at the expiration of the jump start time period or after obtaining ignition.

When the heating function is completed, the control circuitry 240/microcontroller 242 receives a signal from the external switch device 190 calling for the heating device to be turned off. In the case of a cook top, this would be when the user actuates the external switch device 190 (e.g., control knob 26) to be in the off position. In response to such a signal, the control circuitry 240/microcontroller 242 closes the fuel admission valve 108 to cut off the flow of fuel, thereby stopping the combustion process. As also described herein, if the sensor 112 outputs a signal indicating that fuel is being combusted after the external switch device 190 has been placed in the closed position, the control circuitry 240/microcontroller 242 takes additional actions to shut the fuel admission valve 108.

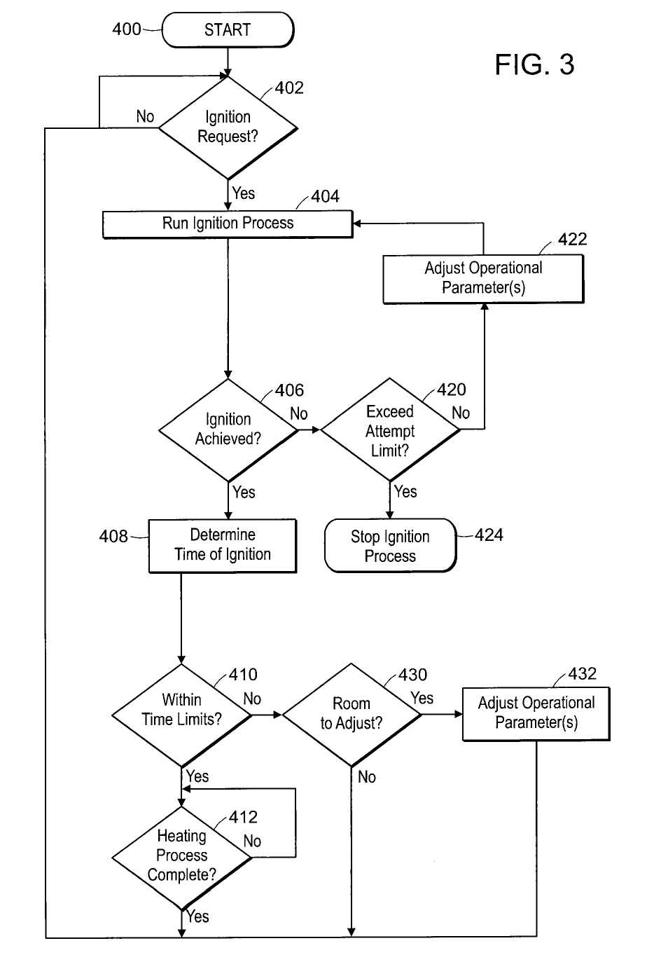

Now referring to FIG. 3, there is shown a high level flow diagram of a process embodied in the ignition system of the present invention, more particularly the process for determining igniter operational parameters/characteristics based on system or igniter performance and for controlling energization of the igniter based on such determined ignition parameters/characteristics. As is known to those skilled in the art, it is within the skill of one skilled in the computer programming arts to develop software code including code segments, instructions and criteria from the flow chart(s) provided herein. Also, while in particular embodiments the process is embodied in software code for execution in the microcontroller 242, it is within the skill of those in the arts, to embody the described process in hardware. As also known to those skilled in the art, the control circuitry 240/microcontroller 242 includes storage devices (e.g., NVRAM, EEPROM, and the like) for storing the program code and other parameters described herein, as well as interfaces (e.g., USB and the like) so the microcontroller can be operably coupled to display and input devices (monitor, mouse, keyboard).

The process is started, Step 400, by initially inputting and storing standard igniter operational parameters or characteristics relating to the energization of the igniter. It also is within the scope of the present invention, that the below described process be performed during testing of the heating apparatus by the manufacturer before shipment/delivery of the apparatus to the end user, such that operational parameters or characteristics are refined and stored before delivery/shipment.

After the heating apparatus, for example the cook top, is installed at the user's site and ready for use by the end user, the ignition system 100 embodied in the apparatus, more particularly the control circuitry 240/microcontroller 242 of such a system awaits a request or signal requesting that the related heating source (e.g., cook top burner) be ignited, Step 402 (ignition request). As indicated herein, an ignition request can be followed by one or more signals to re-adjust or vary the heat output from the heating source. If such an ignition request is not received (No, Step 402), then the control circuitry 240/microcontroller 242 continues to monitor for an ignition request.

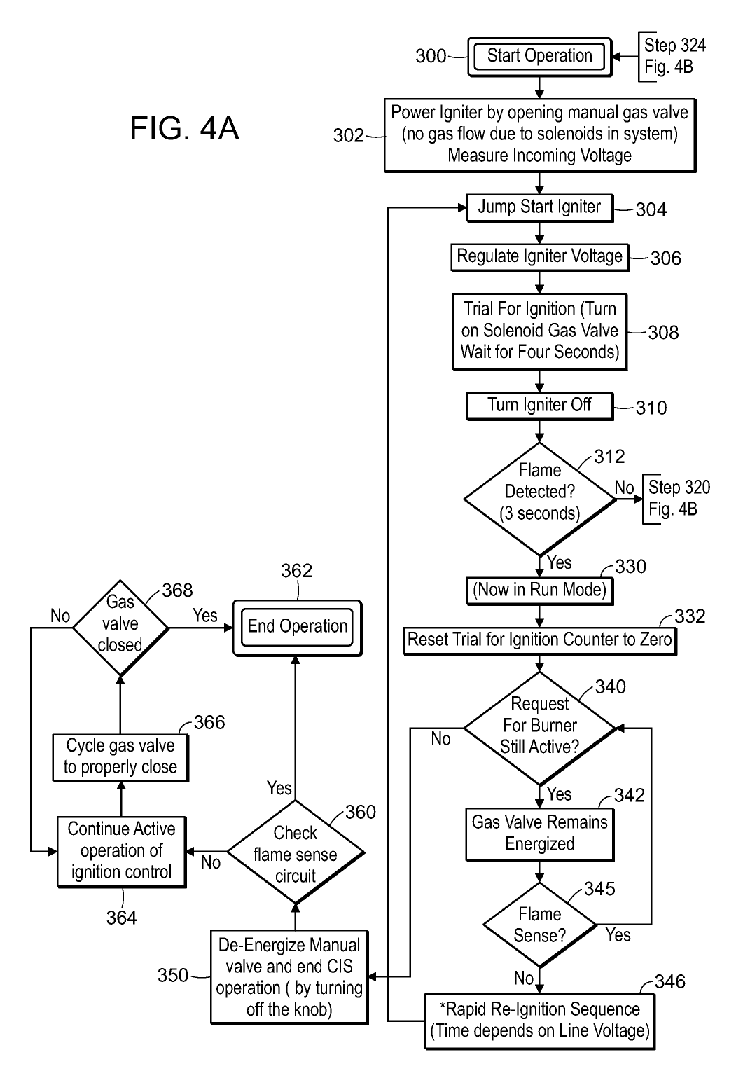

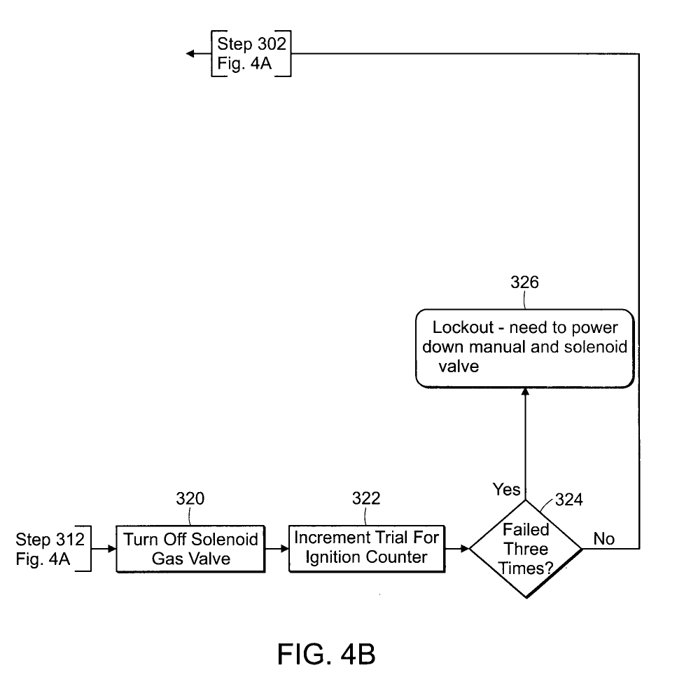

If an ignition request is received (Yes, Step 402) then the process proceeds with running the ignition and running process, Step 404, such as that described in connection with FIGS. 4A, B. In this regard, the ignition process retrieves previously determined and stored operational parameters or characteristics relating to the energization of the igniter to achieve ignition of the fuel air mixture.

As indicated above, the heating apparatus should be initially configured with a set of such parameters or characteristics. After the heating apparatus is put into use at the end user's location, the below described process is followed so as to evaluate igniter performance and to determine from such an evaluation if the parameters should be updated, and if so, to update the parameters (if possible) and to store the updated parameters for the next ignition sequence.

While running the ignition process, an evaluation is made to determine if ignition has been achieved, Step 406. If ignition has not been achieved (No, Step 406), then as described in connection with FIGS. 4A, B, a process is initiated so as to make further attempts to start the igniter until a limit of attempts is reached, Step 420. When the limit is reached the ignition process is stopped, Step 424.

If the limit is not exceeded or met (No, Step 420), then the process makes another attempt to ignite the fuel/air mixture. In such a case, the other attempt can be done using the previously stored operational parameters or characteristics as shown in FIGS. 4 A, B. It also is within the scope of the present invention to adjust the operational parameter(s), Step 422. In such adjusting, criterion can be provided so to increase the supply voltage, increase the jump start voltage and/or jump start time a predetermined or incremental amount.

If ignition is achieved (Yes, Step 406), the process continues with the process to evaluate igniter or system performance relating to the ignition of the fuel/air mixture. This process typically proceeds in parallel with the generation of heating energy during operation of the apparatus.

While energizing the igniter, the control circuitry 240/microcontroller 242 monitors the sensing device or sensing means for a signal indicating that ignition has been achieved. In other words, the control circuitry 240/microcontroller 242 monitors for a signal indicating that flame has been the detected. Using any of a number of techniques known to those skilled in the art, the time of ignition is determined, Step 408. For example, the control circuitry 240/microcontroller 242 counts clock pulses starting when the igniter starts to be energized until the signal indicating start of ignition is received.

The time of ignition is evaluated against predetermined criterion to determine if the time of ignition satisfies the predetermined criterion, Step 410. For example, the control circuitry 240/microcontroller 242 determines if time of ignition is within a desired time range (the predetermined criterion) or not. In other words, the system determines if the fuel/air mixture ignition too fast or too slow, as too fast raises a concern with aging and too slow raises a concern that the igniter is not meeting industry criterion for ignition.

If the predetermined criterion is satisfied (Yes, Step 410), it is next determined if the heating process is complete, Step 412. While this is shown in series with step 410 on FIG. 3, it should be recognized that this process step can be performed in parallel with the process of steps 406, 408, and 410. If it is determined that the heating process is complete (Yes, Step 412), then steps are taken to terminate the heating process and the process returns to monitoring for an ignition request, Step 402.

If the predetermined criterion is not satisfied (No, Step 410), it is next determined if there is room to adjust, Step 430. As a practical matter, there are limits as to how much the supply voltage can be raised and how long or how short the jump voltage can be applied to the igniter. Thus, if the operational parameters or characteristics are at their respective limits, (No, Step 430) there is, practically speaking, no room for adjustment. Therefore, if this is the case, the process returns to waiting for another ignition request, Step 402. In such a case, it is contemplated, and thus within the scope of the present invention, to provide an auditory or visual cue and/or provide an output signal to a monitoring location to indicate that there is a problem with the igniter or related circuitry.

If, on the other hand, it is determined that there is room to adjust the operational parameters or characteristics (Yes, Step 430), then the process proceeds with adjusting the igniter operational parameters and storing the adjusted parameters, Step 432. Thereafter the process returns to awaiting another ignition request, Step 402, where the new operational parameters or characters that are stored are used in the ignition process after receiving the next ignition request.

In this regard, consideration is given to adjusting the operational parameters if the time for ignition is too short or too long. If the time of ignition is too short, the control circuitry 240/microcontroller 242 may adjust the operational parameters in a couple of ways: (a) the control circuitry 240/microcontroller 242 lowers the supply voltage to the igniter; or (b) adjusts (e.g., decrease) the “jump start” timing if a jump start function is being employed. If the time of ignition is too long, the control circuitry 240/microcontroller 242 (a) increases the supply voltage and/or (b) adjusts (e.g., increase) the “jump start” time to shorten the ignition time. As described herein, the modulation or adjustment of the supply voltage is accomplished using any of a number of techniques known to those skilled in the art such as by wave chopping or duty cycling of the supply voltage, such as described herein in connection with FIGS. 4 A, B.

In this process, voltage and/or time is being regulated by the circuit for purposes of providing for a longer igniter service life as compared to the life of the igniter when using conventional ignition systems.

In further embodiments, the process is adaptable so that whether or not the time of ignition is within the time limits, the time and/or voltage is adjusted incrementally so as to provide the minimum temperature required for ignition. In the case of a continuous (constant On) mode of operation, this provides a mechanism for providing reliable igniter operation.

In yet further embodiments, the above described control circuitry 240/microcontroller 242 is usable to arrive at supply voltages and/or jump start timings for each try when the system makes multiple tries for ignition.

In yet further embodiments, the control circuitry 240/microcontroller 242 is configurable so as to cause the supply voltage to be immediately reduced after ignition is obtained or, alternatively, to turn the supply voltage off when ignition is obtained. This should reduce the potential for the igniter to overheat, as well as limiting its time at operating temperature.

In yet further embodiments, the above described control circuitry 240/microcontroller 242 is configurable so that it employs the jump start timing, voltage level adjustment, and immediate shutdown of the igniter either independently or in combination.

Referring now to FIGS. 4A-B, there is shown a high level flow diagram illustrating the process for controlling ignition, controlling admission, and controlling the energization of the igniter. Such a process is also configurable so as to embody the methods and techniques as described above in connection with FIG. 3. Also shown are processes for putting a burner into a safe condition when the ignition system 100 of the present invention detects out of normal conditions. More particularly, the flow charts describe the process embodied in the microcontroller 242. As is known to those skilled in the art, it is within the skill of one skilled in the computer programming arts to develop software code including code segments, instructions and criteria from the flow chart(s) provided herein. Also, while in particular embodiments the process is embodied in software code for execution in the microcontroller 242, it is within the skill of those in the arts, to embody the described process in hardware. As is also known to those skilled in the art, the control circuitry 240/microcontroller 242 includes storage devices (e.g., NVRAM, EEPROM, and the like) for storing the program code and other parameters described herein) as well as interfaces (e.g., USB and the like) so the microcontroller can be operably coupled to display and input devices (monitor, mouse, keyboard).

In particular embodiments, the microcontroller 242 is continuously powered (i.e., coupled to the power source 4) so that it is capable of controlling operation under different operating modes of the cook top, appliance or heating devices. The appliance, cook top, heating device is put into operation, Step 300, by any of a number of actions. For example, the user turns the knob or a manual valve or switch representing the external switch device 190 or a signal from a switching or sensing device 190 (e.g., thermostat) is received. This action opens the manual valve and makes an electrical contact to initiate the sequence for powering the igniter. It should be noted that as the solenoid or other electronically actuated/controlled valve 108, which is inline with the manual valve, is closed, there is no flow of fuel to the burner.

In one embodiment, with the relay activated in Step 300, full line voltage is applied to the selected igniter and the control circuitry 240/microcontroller 242 measures the line voltage, Step 302. In particular exemplary embodiments the line voltage is measured for the first 200 ms. Based on the measured line voltage from step 302 the control circuitry 240/microcontroller 242 selects the required “jump start” timing from the lookup table, Step 304. The igniter is “jump started” for the defined time period. After the “jump start” time period has elapsed, the control circuitry 240/microcontroller 242 regulates the voltage to the igniter for the remainder of the igniter on time, Step 306.

When the jump start period is initiated, the control circuitry 240/microcontroller 242 turns on the solenoid valve (fuel admission valve 108) to the burner, Step 308. In more particular embodiments, the solenoid valve(s) to both rings of the burner are turned on. After a predetermined period of time has elapsed thereafter the igniter is turned off, Step 310. The predetermined time is based on industry standards and practices and in an exemplary embodiment the predetermined time is 4 seconds.

In alternative embodiments, and with reference to FIG. 3, when the relay is activated, step 300, the control circuitry 240/microcontroller 242 causes a supply voltage to be applied to the igniter continuously until the combustion process is to be terminated or for a predetermined period of time such as when using a jump start igniter heating technique. In this case, the supply voltage(s) to be applied to the igniter and the predetermined igniter operating time(s) are previously determined using the processes and methods described in connection with FIG. 3. In addition, it is within the scope of the present invention for the control circuitry 240/microcontroller 242 to adjust these predetermined voltage(s) and operating time(s) to account for variation of the line voltage for the nominal value.

The control circuitry 240/microcontroller 242 is configured so as to continuously sense for the presence or absence of a flame to determine if ignition has occurred after heating of the igniter. In particular embodiments, the control circuitry 240/microcontroller 242 moves into the flame sensing mode to determine if a flame is detected for more than a predetermined period of time (Step 312), where the predetermined period of time is based on industry standards and practices. In an exemplary embodiment the predetermined time is a 3 second duration.

If the flame sense circuit does not detect a flame (No, Step 312), then the solenoid valves are deactivated or turned off by the control circuitry 240/microcontroller 242, Step 320 (FIG. 4B) and the trial for ignition counter is incremented by one, Step 322. The control circuitry/microcontroller then counts the number of trials for ignition and determines if the number of trials is less than or equal to a preset number of trials (N), Step 324. In an illustrative embodiment N is three. If the number of trials is less than or equal to N (No, Step 324), then the process returns to step 302 and the system initiates another ignition sequence.

If the number of trials is greater than N (Yes, Step 324), for example if there have been 3 trials for ignition without a successful burner ignition, then the process proceeds to Step 326. In Step 326, the system moves to a lockout condition where the system will not allow any further attempts to ignite the burner and thus terminates the process that had been started. In particular embodiments, the burner logic is reset after such a lockout by having the user turn the manual knob 190 into the off position, which powers down the gas admission valve 108 and resets the manual valve switch. This should reset the ignition system 100 thereby allowing the user to again try and turn the failed burner on (i.e., restarting the process at Step 300).

Referring now back to the process shown on FIG. 4A, if the flame sense circuit does detect a flame (Yes, Step 312), then the system is put into the run mode, Step 330 and the control circuitry 240/microcontroller 242, sets the trial for ignition counter to zero, Step 332. As also described above in more detail in connection with FIG. 3, when the flame sense circuit detects a flame that is representative of the start of the ignition process, a signal is outputted. This signal is utilized by the control circuitry 240/microcontroller 242 to determine the time of ignition and also if the determined time of ignition is within a desired time range. If the time of ignition is outside the desired time range, the control circuitry 240/microcontroller 242 performs a process to determine revised or new operation parameters or characteristics that are saved, preferably to a non-volatile storage device, for use in energizing the igniter following receipt of the next ignition request. This evaluation and updating process preferably continues throughout the operational life of the igniter.

When the gas flame is detected and the call for burner operation is active (the knob is turned on) and the system is in the run mode, the flame sense circuitry continuously monitors the gas flame of the active burner. Also, a determination is periodically made to determine if the burner is still active, Step 340. If there was a call for burner operation to end (No, Step 340) then the system stops operation of the burner, Step 350.

If the burner operation is continuing and the system remains in the run mode, (Yes, Step 340) the solenoid valve(s) or gas admission valve(s) remain open or active, Step 342, and the flame sense circuitry continues to monitor the burner flame, Step 345. If flame is detected (Yes, Step 345), the system remains in the run mode and the process returns to steps 340. If the flame sense detects a loss of flame (No, Step 345), then the system moves to a rapid re-ignition mode, Step 346.

The rapid re-ignition mode, Step 346, is used in the case where a flame failure is detected during gas burner operation. The rapid re-ignition operation is a means by which a hot surface igniter can be made to relight the burner in less than 4 seconds and without deactivating the gas supply to the burner. In the rapid re-ignition mode, the following operational sequences are performed: the burner is ignited and the igniter is operated in flame sense mode; a determination is made as to flame failure; full line voltage is applied to the igniter for a time increment defined by measured line voltage level; the igniter “jump starts” to ignition temperature in about 2 seconds; the burner is re-ignited; the system regulates the voltage to the igniter for the remainder of the “on” time; the igniter shuts down and moves into the flame sense mode; and the flame sense operation continues to monitor the burner flame.

In the case where the user has ended the operating sequence by turning the knob into the Off position (Step 350), and in further embodiments of the present invention, a post-operation flame sense circuit check is made to determine if there is no flame, Step 360. If the flame sense circuit does not show the presence of a flame (Yes, Step 360), system operation is ended, Step 362.

If the flame sense circuit shows that a flame is still present after the operating sequence is ended (No, Step 360), the system is returned to a continuous operating mode, Step 364. In addition, the control circuitry 240/microcontroller 242 outputs signals to cycle the fuel admission valve 108 as an attempt to properly close the valve 108 and thus end the gas flow to the burner, Step 366. A determination is made using the flame sense circuit to determine if the gas valve has closed, Step 368. If the gas valve is determined to have closed (Yes, Step 368), then the process proceeds to Step 362 and operation is ended. If it is determined that the gas valve has not closed (No, Step 368), the process returns to Step 364.

In the discussion regarding FIGS. 4A, B, reference is made to applying different voltages to the igniter at different times. In one embodiment of the present invention, the jump start voltage process referred to herein is the process and mechanisms described in U.S. Patent Application No. 61/196,759 as filed by at least one of the Applicants of the present invention. The teachings of this application are incorporated herein by reference and reference shall be made to this application for more specific details of the structure and operation of such processes and devices.

As more particularly described herein, the ignition system 100 of the present invention is operated so the hot surface igniter 20 is de-energized during those times when heat energy is not being produced by the appliance or heating device. Thus, during such non-heat producing times the igniter control circuitry 244 is in an idle state. In alternative embodiments, it is within the scope of the present invention for the igniter to be de-energized and thus returned to the idle state after it is determined that combustion of the fuel/air mixture is self-sustaining.

As described herein, when heat energy is to be produced by the appliance or heating device, an input signal is provided to the microcontroller 242, such a signal corresponds to a signal to energize the one or more hot surface igniters 120. Following receipt of this input signal, the microcontroller outputs a signal (e.g., a gate pulse) to a triac or thyristor of the igniter control circuitry 244 to fire the thyristor so that current from the power source 4 flows through the one or more hot surface igniters 120. More particularly, the microcontroller 242 controls the triac or thyristor so that such current flows continuously and so a first regulated voltage is supplied to the hot surface igniter(s) 120. The first regulated voltage typically produces an over voltage condition, that is the voltage developed across the hot surface igniter(s) 120 is more than nominal operating voltage for the igniter(s). Consequently, the hot surface igniter(s) 120 heats faster to a given temperature and also will produce more heat energy in the igniter(s). In yet further embodiments, the control circuitry 240/microcontroller 242 controls the triac or thyristor of the igniter control circuitry 244 so as to develop the supply voltage(s) and/or for the time periods determined in connection with the processes described in FIG. 3.

As indicated above, in one embodiment, a line voltage measuring apparatus within the igniter control circuitry 244 monitors the line voltage of the power source 4 and provides output signals representative of the line voltage to the microcontroller 242. After receiving such an energizing signal, the microcontroller 242 processes the output signals from the line voltage measuring apparatus to determine the amplitude of the line voltage. In the United States where the specified line voltage is 220 VAC, the nominal line voltage typically ranges between about 208 VAC and about 240 VAC. In Europe and other parts of the world where the specified line voltage is 230 VAC, the nominal line voltage typically ranges between about 220 VAC and about 240 VAC. Thus, line voltage variance universally can range anywhere between about 176 VAC and about 264 VAC. In the United States, there are cases where other nominal line voltages are found; in one case the nominal line voltage is 120 VAC, which ranges between 102 VAC and 132 VAC and in another case the nominal line voltage is 24 VAC, which ranges between 20 VAC and 26 VAC.

The microcontroller 242 evaluates the determined or measured line voltage and the microprocessor thereof controls the triac or thyristor to regulate the voltage being applied or delivered to the hot surface igniter(s) 120 to maintain the voltage about a first voltage for the igniter. In more particular embodiments, the first voltage is a voltage that is higher than the second regulated voltage and is set so as cause the igniter to heat up rapidly thereby reducing warm up time so as to be in a set range. In further embodiments, the second voltage also is less than the voltage outputted by a power supply and/or power source 4. This includes the case where the power supply includes or embodies a mechanism that steps down the voltage. In more specific embodiments, the first voltage also is set so as to not significantly reduce operating life of the igniter.

In yet further embodiments, the first voltage is set so that the voltage being applied satisfies the following relationship: V₁ₛₜ=Vₙₒₘ+(Vₙₒₘ·c), where V₁ₛₜ is the first voltage, Vₙₒₘ is the nominal operating voltage of the low voltage igniter and c is a number that satisfies the following relationship 0.1≦c≦0.4. It shall be understood that low voltage igniters, as that term is used in the subject application, shall mean igniters whose nominal operating voltage is about 60 volts or less, such as, for example, igniters whose nominal operating voltage is about 6 volts, 12 volts, 18 volts, 24 volts, or 60 volts.

As also described above, in another embodiment the control circuitry 240/microcontroller 242 using previously determined operational parameters or characteristics for energizing the igniter, energizes the igniter using such operational parameters or characteristics so as to heat the igniter to a temperature at which the fuel/air mixture should ignite. Such predetermined operational parameters or characteristics are determined as described in connection with FIG. 3 and stored in a non-volatile storage device. It is within the scope of the present invention to adjust these operational parameters or characteristics so as to compensate for differences in line voltage from nominal.

In an exemplary embodiment, the control circuitry 240/microcontroller 242 controls the triac or thyristor so as to regulate the voltage being applied by duty cycling the AC line voltage in half-wave cycle increments. More particularly, the microprocessor uses the output signals from the zero cross circuitry to control the operation of the triac or thyristor in these half-wave cycle increments. In more specific embodiment's, the regulation method being implemented by the microprocessor regulates the voltage being applied by duty cycling the AC line voltage in half-wave cycle increments with a period of about 50 half-wave cycles that are divided further into sub-periods of about 5 half-wave cycles each to minimize flickering.

The following example illustrates the application of this regulation method in the case where a nominal voltage of 150 VAC is being applied to a hot surface igniter(s). If it is determined that 32 out of the 50 half-wave cycles are needed to regulate the voltage being applied so as to maintain a 150 VAC nominal voltage, then the half-cycles will be distributed in the sub-periods as follows: eight of the 10 sub-periods in the duty cycle would have three half-wave cycles (8·3=24) and the remaining two sub-periods would have four half-wave cycles (2·4=8). Assuming that the two sub-periods with four half-wave cycles are the first and second sub-periods (SP-1 and SP-2, respectively), the microprocessor regulates output voltage to the hot surface igniter(s) by turning on the triac or thyristor for four half-wave cycles and turning it off for one half-wave cycle during the first sub-period (SP-1); turning it on for another four half-wave cycles (SP-2); turning it off for one half-wave cycle; turning it on for three half-wave cycles (SP-3); and so forth to the tenth sub-period (SP-10).

In more particular embodiments, the control circuitry 240/microcontroller 242 further includes a nonvolatile memory that includes a look-up table that associates line voltage from the power source with the number of half-wave cycles needed to regulate the voltage being applied to the hot surface igniter 120 so the voltage being applied is maintained at or about the first voltage. Those skilled in the art can appreciate that the period of the half-wave cycle, the number of sub-periods, and/or the number of half-wave cycles per sub-period can be modified from that described herein and such modification is within the scope and spirit of the present invention. As also indicated herein such a nonvolatile memory or storage device also is utilized to store operational parameters or characteristics for the energization of the igniter.

In further embodiments, the microcontroller 242 evaluates the determined or measured line voltage and periodically makes adjustments to the duty cycle so that the second regulated voltage being applied to the hot surface igniter 120 is being maintained so that the hot surface igniter maintains a fairly consistent temperature. More particularly, the microprocessor or microcontroller compares the newly determined or measured line voltage with the look-up table and determines the number of half-wave cycles needed to regulate the voltage being applied to the hot surface igniter 120 so the voltage being applied is maintained at or about the nominal operating voltage for the igniter.

In further embodiments, the look up table further includes an on-time for applying the first regulated voltage to the hot surface igniter 120. In particular embodiments, a time period is set equal to the on-time and the control circuitry 240/microcontroller 242 continuously determines if this time has expired. If it is determined that the time period has not expired, then the microcontroller 242 controls the triac or thyristor so that the first regulated voltage continues to be applied or delivered to the hot surface igniter(s) 120. If it is determined that the time period has expired, then the microprocessor controls the triac or thyristor to regulate the voltage being applied by the triac or thyristor at a second regulated voltage.

After the first regulated voltage on-time has expired, the microprocessor 242 controls the triac or thyristor to regulate the voltage being applied or delivered to the hot surface igniter(s) 120 to maintain the voltage at the second regulated voltage to the igniter. As described above, in an exemplary embodiment, the microprocessor 242 controls the triac or thyristor so as to regulate the voltage being applied as the second regulated voltage by duty cycling the AC line voltage in half-wave cycle increments.

In more particular embodiments, the second regulated voltage is lower than the first regulated voltage. In more specific embodiments, the second regulated voltage is regulated so as to be at or about the nominal operating voltage specified for the hot surface igniter 120. In yet more specific embodiments, the second regulated voltage is regulated so as to be about the nominal operating voltage of the hot surface igniter 120, and in even yet more specific embodiments, the second regulated voltage is regulated so as to be essentially the nominal operating voltage of the hot surface igniter 120.

In more particular embodiments, the nonvolatile memory further includes in the look-up table an association of line voltage from the power source with the number of half-wave cycles needed to regulate the voltage being applied to the hot surface igniter 120 so the applied voltage is maintained at or about the second regulated voltage. Those skilled in the art can appreciate that the period of the half-wave cycle, the number of sub-periods, and/or the number of half-wave cycles per sub-period can be modified from that described herein and such modification is within the scope and spirit of the present invention. As also described above, in further embodiments, the microcontroller 242 evaluates the determined or measured line voltage and periodically makes adjustments to the duty cycle so that the voltage being applied to the hot surface igniter 120 is maintained so that the hot surface igniter maintains a fairly consistent temperature.

Once the microprocessor 242 has initiated the application of the second regulated voltage to the igniter 120, the microprocessor 242 continuously determines if the energization cycle of the hot surface igniter 120 is complete or done. Typically, the microprocessor 242 receives an input signal from an external sensor or switch indicating that the heating process should be terminated or that a stable combustion process has been established within a heating device such that an ignition source is no longer required. If it is determined that the energization cycle is complete, then the microprocessor 242 provides the appropriate outputs that blocks current flow through the triac or thyristor and continues to control the system. If it is determined that the energy station cycle is not complete, then the microprocessor 242 continues to regulate the second regulated voltage being applied to the hot surface igniter 120.

In another embodiment, the heat-up or energization of the igniter 120 uses the methods, techniques, and/or systems described in U.S. Pat. No. 7,148,454, the teachings of which are incorporated herein by reference.

As indicated above, the heat-up or energization of the igniter 120 utilizes the methods, techniques, and/or systems described in connection with FIG. 3.

Although a preferred embodiment of the invention has been described using specific terms, such description is for illustrative purposes only, and it is to be understood that changes and variations may be made without departing from the spirit or scope of the following claims. In particular the system and method described in connection with FIGS. 4 A, B are adaptable to embody the system and method described in connection with FIG. 3.

### INCORPORATION BY REFERENCE

All patents, published patent applications, and other references disclosed herein are hereby expressly incorporated in their entireties by reference.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. An ignition system used in a fuel burning apparatus, said system including:
a hot surface igniter;
a gas valve;
a microcontroller having a microprocessor;
a software program for execution on the microprocessor for controlling operation of the ignition system;
wherein the software program includes code segments, instructions and criteria for:
controlling operation of the hot surface igniter, operation of the gas valve and ignition of a gas by the hot surface igniter;
evaluating performance characteristics relating to operation of the igniter to ignition; and
determining operation parameters and characteristics for energizing the igniter when said evaluating determines that the operation parameters and characteristics for energizing should be updated.

2. The ignition system of claim 1, further including a flame sensing means for sensing presence or absence of a burner flame and wherein said software program performs the evaluating and determining processes based on a signal from the flame sensing means when ignition is begun.

3. The ignition system of claim 2, wherein the provided instructions and criteria further include instructions and criteria for using a flame sensing signal to trigger an electronically actuated gas valve of one of the types commonly used in the industry.

4. The ignition system of claim 1, wherein
the fuel burning apparatus includes a control knob;
the gas valve is an electronically controllable valve; and
wherein the instructions and criteria include instructions and criteria for controlling the gas valve responsive to action of the control knob.
